(19) United States
(12) Patent Application Publication
(10) Pub. No.: US 2022/0002033 A1
(43) Pub. Date: Jan. 6, 2022

(54) SEMI-RIGID SILICONE CLOSABLE CONTAINER

(71) Applicant: VESSEL CONCEPTS, LLC, Bend, OR (US)

(72) Inventors: Karla Braude, Bend, OR (US); Taylor Prescott, Bend, OR (US); Trevor Hansen, Bend, OR (US)

(21) Appl. No.: 16/917,904

(22) Filed: Jul. 1, 2020

(51) Int. Cl. B65D 43/02; B65D 25/56; B65D 21/02; C07B 37/06

(52) U.S. Cl. CPC B65D 43/0208; C07B 37/06; B65D 21/0209; B65D 25/56

(57) ABSTRACT

In some implementations a closable container includes at least (a) a semi-rigid tub that is composed at least partly of silicone and that includes at least (1) a base wall, including a floor of the tub; (2) one or more side walls defining a junction with the base wall and extending from the junction to a rim, the one or more side walls including one or more interior surfaces that together with the floor define an interior chamber of the tub; and (3) at least one window formed in at least one side wall of the one or more side walls that is at least one of at least partially transparent or translucent. The closable container also includes at least a semi-rigid lid composed at least partially of silicone and configured to sealingly mate with the one or more side walls via the rim.

### TECHNICAL FIELD

Certain implementations pertain to a semi-rigid silicone closable container with a lid. Particular implementations pertain to a semi-rigid silicone closable container with a lid that is configured for preparation, chilling, heating, transport, and storage of products.

### BACKGROUND

The existing market often uses glass, plastic or metal containers. These types of containers have limitations. Many of these containers are used once and thrown away. Glass, plastic, and metal containers are often not flexible. Glass is also breakable. Especially under extreme cold or heat. And plastic is often inflexible. It can leak toxins, especially when used as a container to heat food. Plastic also melts or burns under intense heats, such as used in cooking. Metal is not transparent. The above limitations make these types of containers less desirable for the preparation, chilling, heating, transport, and storage of products.

Thus, there is a need for a sustainable and reusable container for all operational procedures.

### SUMMARY OF EXEMPLARY IMPLEMENTATION(S)

The following summary introduces at a high level a limited number of topics described in the Detailed Description. This summary is not intended to identify key or essential features and should not be used for that purpose. In addition, this summary is not intended to be used as a guide to the scope of the claims. Instead, this Summary is provided as an introduction for the reader.

In some implementations a closable container includes at least (a) a semi-rigid tub that is composed at least partly of silicone and that includes at least (1) a base wall, including a floor of the tub; (2) one or more side walls defining a junction with the base wall and extending from the junction to a rim, the one or more side walls including one or more interior surfaces that together with the floor define an interior chamber of the tub; and (3) at least one window formed in at least one side wall of the one or more side walls that is at least one of at least partially transparent or translucent.

The closable container also further includes at least a semi-rigid lid composed at least partially of silicone and configured to sealingly mate with the one or more side walls via the rim.

### BRIEF DESCRIPTION OF THE DRAWINGS

Various implementations will be described with reference to the following drawings.

FIG. 1 is a perspective view of an exemplary closable container, consistent with some implementations, showing a lid attached to a tub, a window in a side wall, and further showing Section lines AA, indicating a cutting plane and a direction of view for sectional drawings 4, 6, 7, 8, 10 and 12 below. Also shown is a horizontal surface upon which the closable container is resting.

FIG. 2 is a side view of the exemplary closable container of FIG. 1, showing more detail of the window in the side wall, consistent with some implementations.

FIG. 3 is a perspective view of the exemplary closable container of FIG. 1, showing an exterior of a base wall of the tub, consistent with some implementations.

FIG. 4 is a cross-sectional perspective view of the exemplary closable container of FIG. 1, showing cross sectional views of the lid, the tub, and other features consistent with some implementations. The cross-sectional perspective view has a direction of view consistent with that indicated by Section Lines A-A of FIG. 1.

FIG. 5 is a top view, orthogonal with respect to the surface of FIG. 1, of the tub associated with the exemplary closable container of FIG. 1, showing rigid edges and corners configured to function as pour spouts, consistent with some implementations.

FIG. 6 is a cross-sectional perspective view of the lid of FIG. 1, showing a cross-sectional view of the lid, including a portion of the channel closure system, consistent with some implementations. The direction of view is consistent with that indicated by Section Lines A-A of FIG. 1.

FIG. 7 is a cross-sectional side view of the exemplary closeable container of FIG. 1, showing cross-sectional views of the lid and tub, with the lid not attached to the tub. The direction of view is consistent with that indicated by Section Lines A-A of FIG. 1.

FIG. 8 is a cross-sectional side view of two closable containers that are each at least similar to the closeable container of FIG. 1, showing one closable container stacked on top of the other closable container. The direction of view is consistent with that indicated by Section Lines A-A of FIG. 1.

FIG. 9 is a top view of a plurality of tubs showing a plurality of shapes associated the tubs of the plurality of tubs. The top view being orthogonal relative to a surface that base walls of the tubs could be supported on, similar to the surface of FIG. 1.

FIG. 10 is a cross-sectional side view of the exemplary closeable container of FIG. 1, showing cross-sectional views of the lid and tub, with the lid attached to the tub. The direction of view is consistent with that indicated by Section Lines A-A of FIG. 1.

FIG. 11 is a simplified cross-sectional top view of the exemplary closable container of FIG. 1 showing only a cross-sectional view of the side walls and rigid edges formed by the side walls, showing a greater thickness at the rigid edges as compared with the side walls.

FIG. 12 is a cross-sectional side view of the lid of FIG. 1, showing a portion of a channel closure system, consistent with some implementations. The direction of view is consistent with that indicated by Section Lines A-A of FIG. 1.

FIG. 13 is a perspective view of a user holding the tub of the exemplary closable container of FIG. 1 and pouring a liquid from the tub via a corner which functions as a pour spout.

FIG. 14 is a flow chart illustrating an exemplary method of using an closable container to process crude oil into a product.

### DETAILED DESCRIPTION

Some implementations are now described with reference to the above-described drawings. The drawings are simplified drawings which omit various details to focus on what is described in this detailed description. The omission of various details is not intended to imply that these various details would not be present in an actual physical implementation. Instead, omissions of various details are merely to avoid clutter in the presentation and to aid ease of explanation and understanding. Further, these simplified drawings are intended to illustrate the principles of various described implementations and are not necessarily drawn to scale. Further all drawings are merely examples and not meant as limitations on the description or the claims.

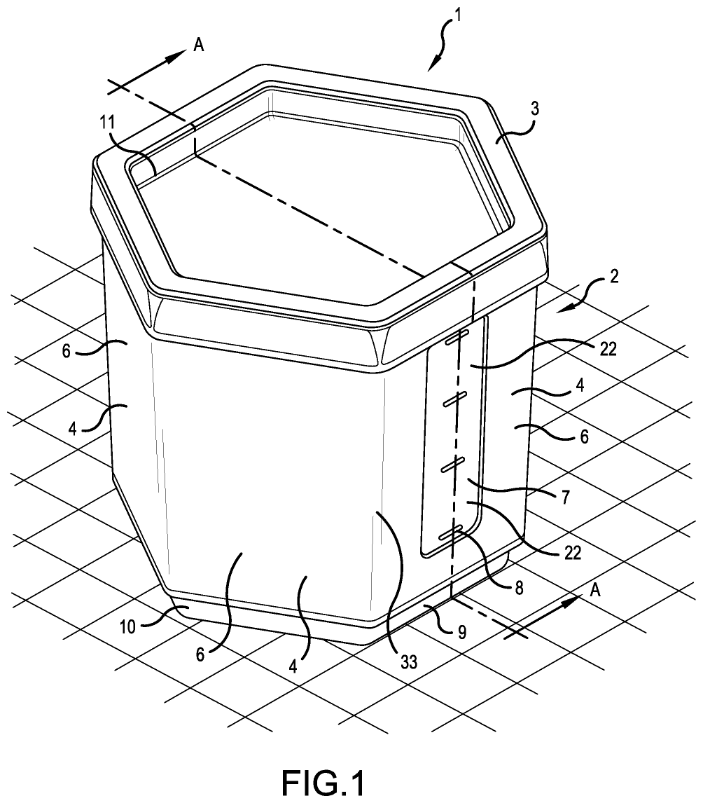

For example, to avoid clutter and for simplicity, a surface supporting a closeable container is only depicted in FIG. 1, but one could imagine that a closeable container being supported on a surface in the remaining drawings. Terms such as “vertical” are intended to be relative to a horizontal status of at least the surface of FIG. 1. Likewise, the term upward is also intended relative to the surface of FIG. 1.

In the following description, reference is often made to “some implementations.” These references to “some implementations” are not necessarily referring to the same implementations, as numerous and varied implementations are possible. Further the various “some implementations” may be alternatives to one another.

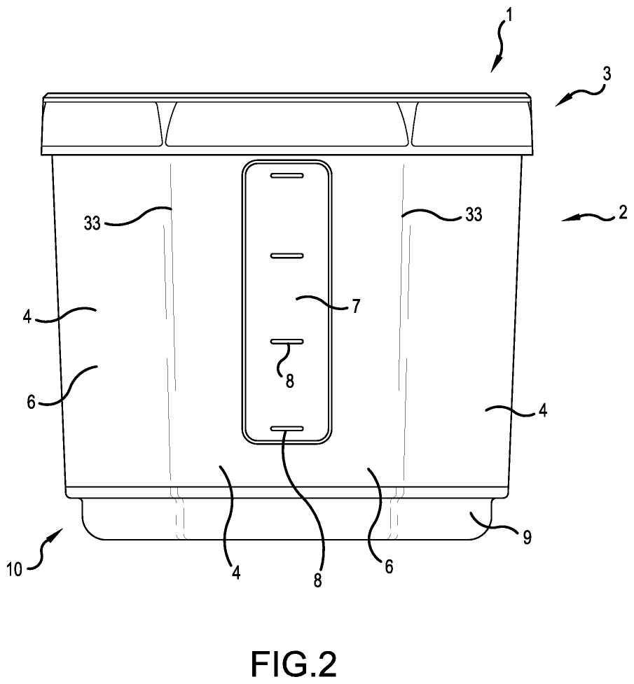

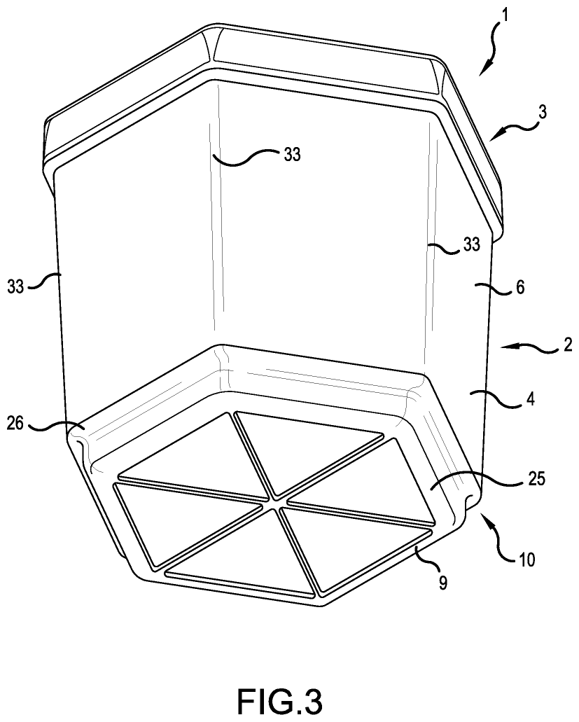

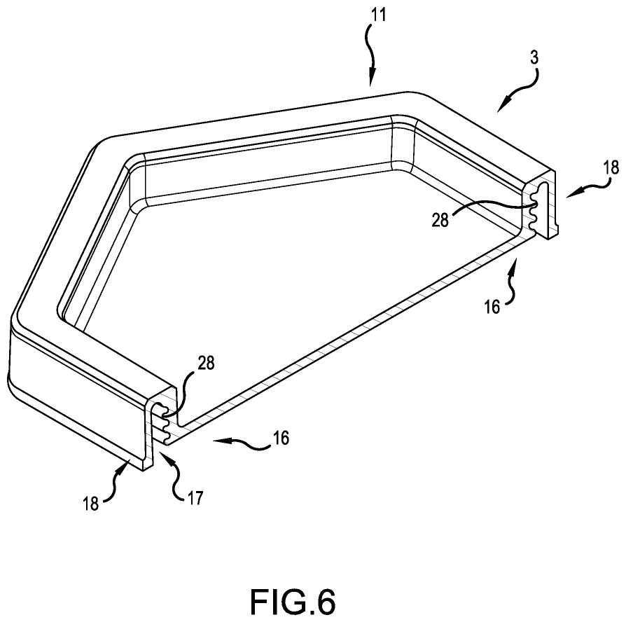

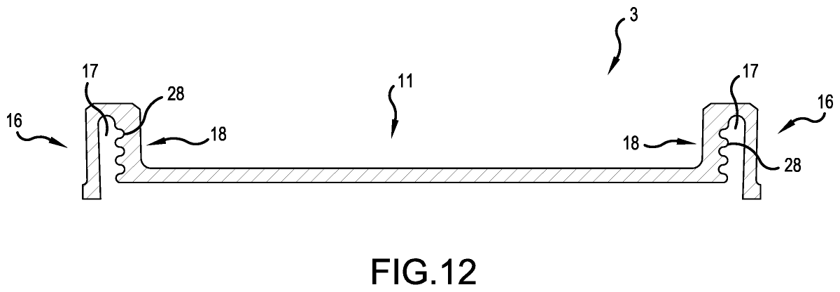

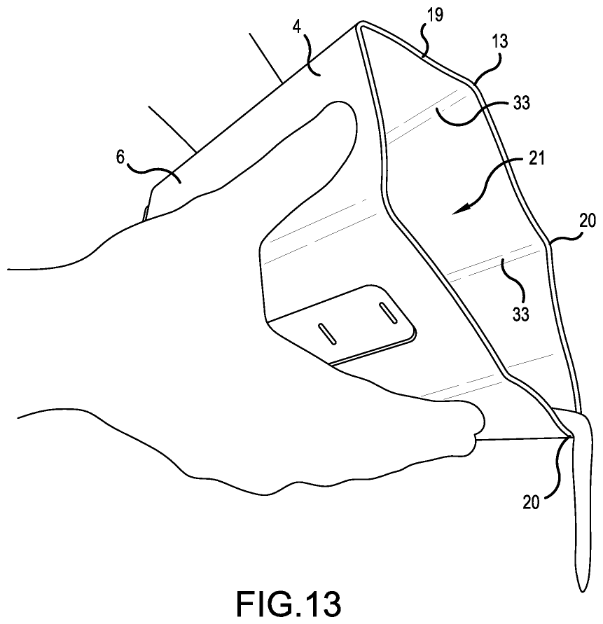

Additionally, there is discussion of one or more diameters defined by various features of a tub or by one or more side walls. In the particular embodiments shown in FIGS. 1-13 with edges or corners, these diameters are intended to run from one wall across to an opposing wall and are not intended to run diagonally from corner to corner or from edge to edge.

Preliminarily, as used in this document, the term “closable container” includes both a tub (e.g., a vessel, receptacle etc. The term “closable container” is used when referring to a combination of a lid and its associated tub.

In addition, as used herein, the term “silicone” is used for its plain meaning to those skilled in the art. In particular implementations “silicone may include any polymer composed of silicon and other elements or materials (e.g. oxygen, hydrogen, carbon). In further particular implementations, “silicone” may include a synthetic polymer composed of elemental silicon, oxygen, and other elements. Silicone has properties that may include semi-rigidity and tolerance for both cold and heat.

In addition, the term “food grade silicone” is well known in the art and includes at least a non-toxic silicone that is suitable for use with foods. Often food grade silicone is made without chemical fillers and byproducts that could be harmful if place in contact with food.

This document discusses closable containers composed at least partly of silicone. Advantages of various silicone containers include their durability, flexibility, temperature resistance, being BPA (bisphenol A) free, non-porous, microwavable, commercial dishwater safe, freezable, and their insulating properties.

In addition, this detailed description discusses a closable container used with cannabinoids. However, this discussion is not intended to be limiting. Cannabinoids are just an example of a type of liquid that can be prepared, chilled, heated, transported, and/or stored in described implementations.

Implementations described herein include a semi-rigid closable container, made at least partly of silicone, that is configured for preparation, chilling, heating, transport, and storage of liquids, such as oils. In some implementations, this closeable container is made of at least 90 percent silicone. In some implementations, this closeable container is made at least partly of food grade silicone.

For example, a liquid (e.g., cannabidiol (CBD) oil) may be poured into an interior chamber of an closable silicone container after first removing the lid. While still inside the closable container, the liquid may be chilled to below freezing temperatures, subjected to high heat, mixed with other substances or additives, and with the lid reattached, stored or transported. Possible final products include at least muscle salves, CBD tinctures, lotions, topical spray or oils, and food products.

In some implementations a closable container may include at least (a) a semi-rigid tub that is composed at least partly of silicone and that includes at least (1) a base wall, including a floor of the tub, (2) one or more side walls defining a junction with the base wall and extending from the junction to a rim, the one or more side walls including one or more interior surfaces that together with the floor define an interior chamber of the tub, and (3) at least one window formed in at least one side wall of the one or more side walls that is at least one of at least partially transparent or translucent; and (b) a semi-rigid lid composed at least partially of silicone and configured to sealingly mate with the one or more side walls via the rim.

One or more advantages provided by some implementations are now described. Nothing requires that any given implementation must supply all or even more than one of the below advantages.

Some implementations provide a closeable container with a lid that firmly attaches to one or more side walls of a tub to seal an interior chamber defined by the tub. The lid and tub includes at least a channel closure system that creates contact friction between the lid and both interior and outer surfaces of the one or more side walls. A lid that is securely attached to the tub is needed for preparation, storage, and/or transport of products in the closeable container—such as for shipment of product in commerce to warehouses, storage facilities, or markets.

In some implementations, two or more thick lateral reinforcing bands encircling the tub may provide lateral reinforcement for the tub of the closeable container. In some implementations two or more thick lateral reinforcing bands horizontally (e.g. parallel to the surface of FIG. 1, parallel to a base wall) encircling the tub.

In some implementations, one or more interior surfaces of the one or more side walls of the tub of the closeable container provide one or more inclined interior bottom surfaces for easier spooning out of contents of the closeable container.

In some implementations, the one or more sidewalls define one or more rigid edges of the tub, providing increased stability for shipping and transport. In some implementations the one or more rigid edges are, for a least a portion of their length, vertical relative to a surface a base wall of a closeable container may be resting on (e.g. see surface 35 of FIG. 1).

In some implementations, a rim defined by the one or more side-walls intersects with the one or more rigid edges to define one or more corners 20. These one or more corners 20 may be configured to function as one or more pour spouts. These one or more pour spouts assist with preparation of product when the preparation of product includes at least an emptying of liquid from the interior chamber of the tub.

In some implementations, one or more windows are provided formed in one or more side walls of the tub of the closeable container. In some implementations these one or more windows include one or more measurement lines at least one of formed on embossed in at least one of an interior or an exterior surface of the one or more windows.

In some implementations, the closeable container includes a combination of a lid with a lid deboss and a base wall configured for insertion into the lid deboss. The lid deboss being defined in a top (e.g. opposite base wall) surface of the lid when the lid is attached to the tub. In some implementations the base wall is at least sized for insertion into the lid deboss In some implementations a base step is defined in at least one of the one or more side walls or the base step, the base step causing a narrowing of the tub at the base wall that configures the base wall with at least a size for insertion of the base wall into the lid deboss. The fitting of the base wall into the lid deboss configuring multiple closeable containers for stacking wherein a first closeable container may be stacked on top of a second closeable container by fitting the base wall of the first container into the lid deboss of the second container. This facilitates stacking of closeable containers for storage or shipment.

Various implementations will now be described with reference to FIGS. 1-13. The drawings depict merely examples of structures described in the written description.

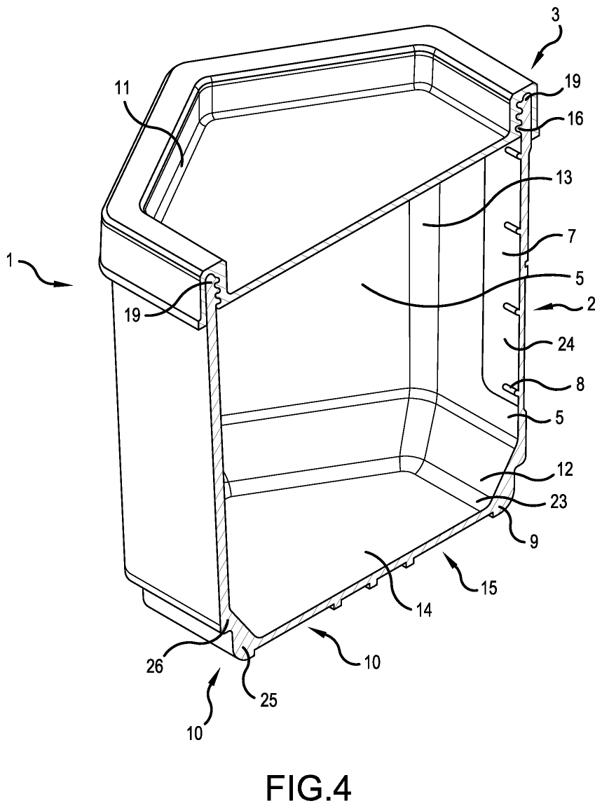

Referencing FIGS. 1-4, 6-7, 10-13 in some implementations a closable container 1 is semi-rigid, made at least partly of silicone and is configured for the preparation, chilling, heating, transport, and storage of liquids, including cannabinoids such cannabinoid oil. The closable container 1 includes at least a tub 2 and a lid 3. Tub 2 may include at least one or more side walls 4 that include one or more interior surfaces 5 and one or more outer surfaces 6. The tub 2 further includes at least a base wall 9 that includes at least a floor 14 and that forms a junction 23 with the one or more side walls 4. The one or more side walls 4 extend from the junction 23 with base wall 9 to a rim 19 opposite the junction 23. The one or more interior surfaces 5 of the one or more side walls 4 and the floor 14 of base wall 9 define an interior chamber 15 (e.g., FIG. 4).

Thus, in some implementations a closeable container (e.g. closable container 1) includes at least a tub (e.g. tub 2) that includes at least (1) a base wall (e.g. base wall 9) including a floor (e.g. floor 14) of the tub (e.g. tub 2); (2) one or more side walls (e.g. side walls 4) defining a junction (e.g. junction 23) with the base wall (e.g. base wall 9) and extending from the junction (e.g. junction 23) to a rim (e.g. rim 19), the one or more side walls (e.g. side walls 4) including one or more interior surfaces (e.g. interior surfaces 5) that together with the floor (e.g. floor 14) define an interior chamber (e.g. interior chamber 15) of the tub (e.g. tub 2). The closeable container (e.g. closeable container 1) further includes at least a semi-rigid lid (e.g. lid 3) composed at least partially of silicone and configured to sealingly mate with the one or more side walls (e.g. side walls 4) via the rim (e.g. rim 19).

In some implementations, the closable container 1 has the ability to manage every step of the cannabinoids manufacturing process from the moment cannabinoids are poured into the tub 2 to the times when they are chilled, heated, mixed with other ingredients, stored, and transported.

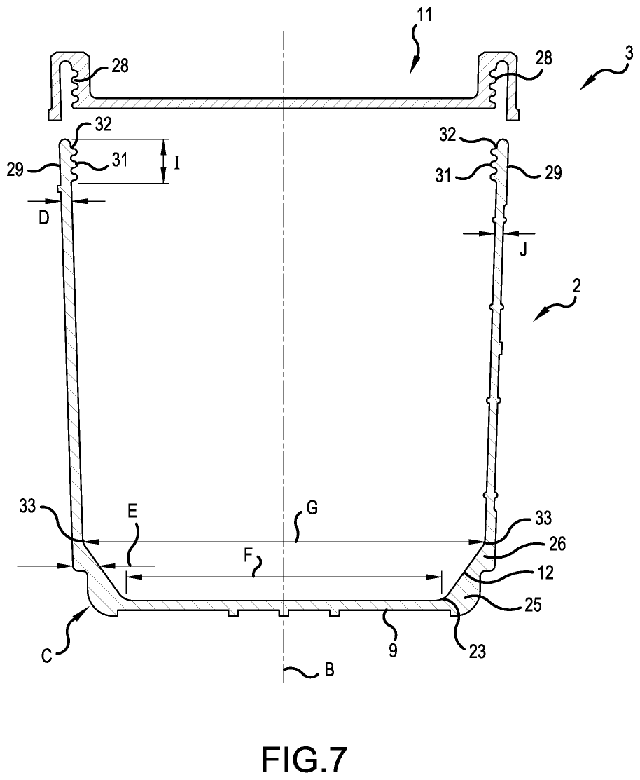

Referencing FIGS. 1, 2, 4, and 7 in some implementations a closable container 1 includes at least a tub 2 with at least one window 7 formed in at least one side wall 4 of the one or more side walls 4. The at least one window 7 being at least one of at least partially transparent or translucent to allow at least some view of any contents within the interior chamber 15 of the tub 2. In some implementations, the at least one window 7 is integral with and of the same material as the at least one side wall 4. The at least one window 7 may have a thickness (e.g. thickness J of FIG. 7) that is less a thickness (e.g. thickness D of FIG. 7) of other portions of the one or more side walls 4. In some implementations the thickness (e.g. thickness J) of the at least one window 7 may be half as thick as the thickness (e.g. thickness D) of other portions of the one or more side walls 4. This reduced thickness (e.g. thickness J) of the at least one window is what renders the at least one window 7 at least one of at least partially transparent or translucent. In some implementations the at least one window 7 is composed at least partly of silicone as is the at least one wall 4 that it is formed in. Thus, in some implementations, a tub (e.g. tub 2) includes at least at least one window (e.g. window 7) formed in at least one side wall (e.g. side walls 4) of the one or more side walls that is at least one of at least partially transparent or translucent.

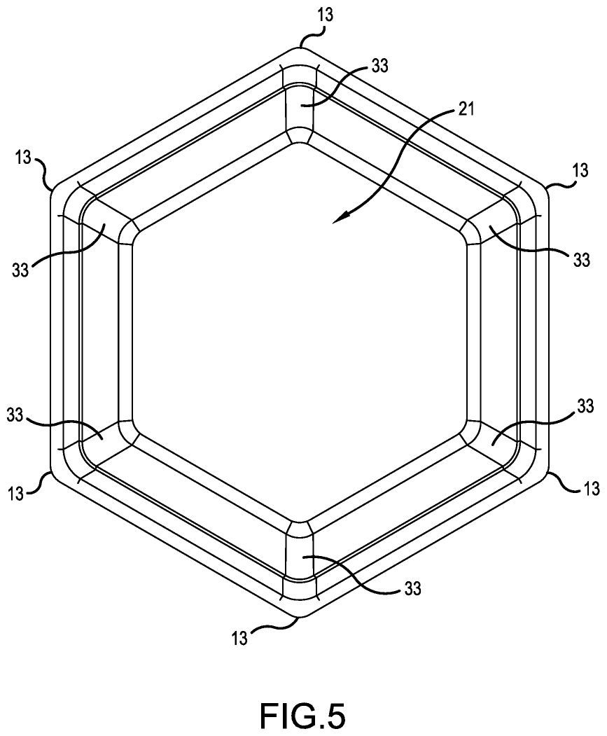

The at least one window 7 may include one or more measurement lines 8 that are at least one of formed or embossed in material of the at least one window 7. In some implementations, the one or more measurement lines 8 are at least one of formed or embossed in material of an exterior side 22 of the at least one window 7 (e.g. for viewing from the outside of the tub 2 when a user is looking through the at least one window 7). In some implementations, the one or more measurement lines 8 are additionally at least one of formed or embossed in material of an interior side 24 (e.g. facing interior chamber 15) of the at least one window 7 (e.g. for viewing when lid 3 is removed for viewing through opening 21 (e.g. as shown in FIG. 5) of interior chamber 15). Thus, in some implementations, the at least one window (e.g. windows 7) includes at least one measurement line (e.g. measurement lines 8) that is at least one or embossed or formed on an interior side (e.g. interior side 24), facing the interior chamber (e.g. interior chamber 15), of the at least one window (e.g. windows 7) and at least one measurement line (e.g. measurement lines 8) that is at least one or embossed or formed on an exterior side (e.g. exterior side 22) of the at least one window (e.g. windows 7). The at least one window 7 with the one or more measurement lines helps with measurement accuracy when pouring liquids into the interior chamber 15, when mixing ingredients in the interior chamber 15, or when checking a status of contents of the interior chamber during storage or transport.

Tub 2 may be made in a variety of ways. In some implementations, tub 2 is made entirely of silicone. In some implementations, tub is at least one of 70 percent, 80 percent or 90 percent silicone. In some implementations, tub is made at least partly of food grade silicone. In some implementations tub 2 is made by molding as a one-piece object. In these implementations (as discussed above) the at least one window 7 may created by making a window portion of the one or more side walls 4 thinner, and by making that same window portion within the mold smoothly polished. In some implementations, the at least one window 7 is created all in one motion—i.e. in one molding step. In these implementations, the one or more measurement lines are built into the side walls of the mold (not shown). They will simply fill with silicone when compression molded to form the one or more measurement lines 8 of the at least one window 7. In some implementations, the at least one window 7 does not include the one or more measurement lines 8.

Referencing FIGS. 1, 3, 4, 7, and 10 in some implementations closable container 1 includes at least a tub 2 with two or more thick lateral reinforcing bands 25, 26 encircling the tub 2 to provide lateral reinforcement. In some implementations the two or more thick lateral reinforcing bands 25, 26 encircle tub horizontally, parallel to base wall 9. For example, a first band 25 may be defined at the junction 23 between the one or more sidewalls 4 and the base wall 4 of the tub 2—the first band 25 defining a perimeter of the base wall 9. In some implementations, the first band 25 may not be at the junction but elsewhere defining a perimeter about the tub 2. In some implementations, a second band 26 may be defined by the one or more sidewalls 4 and may define a second perimeter about tub 2. In some implementations the second band 26 may define an perimeter of a step (see, base step 10, discussed below) formed in the one or more side walls 4. These lateral reinforcing bands 25, 26 provide structural reinforcement to the tub for withstanding action by heavy duty mixers or other equipment. This facilitates preparation of products within the closeable container.

In some implementations first band 25 may have a thickness (e.g. thickness C of FIG. 7) that is greater than a thickness (e.g. thickness D of FIG. 7) of one or portions of the one or more sidewalls 4 that are not associated with a band (e.g. not associated with at least first 25 or second band 26). In some implementations, first band 25 may have a thickness (e.g. thickness C) that is at least twice as great as the thickness (e.g. thickness D) of one or portions of the one or more sidewalls 4 that are not associated with a band (e.g. not associated with at least first 25 or second band 26). In some implementations second band 26 may have a thickness (e.g. thickness E of FIG. 7) that is greater than a thickness (e.g. thickness D of FIG. 7) of one or portions of the one or more sidewalls 4 that are not associated with a band (e.g. not associated with at least first 25 or second band 26). In some implementations, second band 26 may have a thickness (e.g. thickness E) that is at least twice as great as the thickness (e.g. thickness D) of one or portions of the one or more sidewalls 4 that are not associated with a band (e.g. not associated with at least first 25 or second band 26).

Thus, in some implementations, the junction (e.g. junction 23) defines a first band (e.g. first band 25) circumscribing the tub (e.g. tub 2) that has a thickness (e.g. thickness C) that is at least twice as great as a thickness (e.g. thickness D) of at least a portion of the one or more side walls that is not associated with the a band (e.g. not associated with at least first 25 or second band 26). And in some further implementations, the one or more side walls (e.g. side walls 4) define a second band (e.g. second band 7) spaced from first band, the second band having a thickness (e.g. thickness E) that is at least twice as great as the thickness (e.g. thickness D) of the at least a portion of the one or more side walls that is not associated with a band (e.g. not associated with at least first 25 or second band 26).

Referencing FIGS. 4 and 7 in some implementations closable container 1 includes at least a tub 2 that includes at least one or more inclined interior bottom surfaces 12, which are a portion of the one or more interior surfaces 5. The one or more inclined interior bottom surfaces 12 may extend from the junction 23 in a curved or straight configuration upward (e.g. relative to floor 14 of FIG. 4 and surface 35 of FIG. 1) and outward from a center (e.g., outward from center line B of FIG. 7 centered laterally in interior chamber 15 and extending orthogonally to floor 14). The one or more inclined interior bottom surfaces 12 may define a first diameter (e.g. diameter F of FIG. 7) at the junction 23 with the base wall 9 and a second diameter (e.g. diameter G of FIG. 7) at an end 33 of the one or more inclined interior bottom surfaces 12, the second diameter G being greater than the first diameter F. In these implementations the one or more inclined interior bottom surfaces 12 facilitate easy extraction of liquids and other substances from tub 2.

Thus in some implementations, the interior chamber (e.g. interior chamber 15) includes at least one or more inclined interior bottom surfaces (e.g. inclined interior bottom surfaces 12) that extend from the junction (e.g. junction 23), the one or more inclined interior bottom surfaces (e.g. inclined interior bottom surfaces 12) defining at least a first diameter (e.g. diameter F of FIG. 7) at the junction (e.g. junction 23) and further defining t least a second diameter (e.g. diameter G of FIG. 7) at an end (e.g. end 33) of the one or more inclined interior bottom surfaces (e.g. inclined interior bottom surfaces 12), the second diameter (e.g. diameter G of FIG. 7) being greater than the first diameter (e.g. diameter F of FIG. 7).

One or more rigid edges are now described with reference to FIGS. 1-3 and 11. In some implementations, the one or more sidewalls 4 define one or more rigid edges 33. In some implementations the one or more rigid edges 33 are vertical relative to the surface 35 (e.g. relative to horizontal status of surface 35 of FIG. 1 (e.g. a table top, a floor, a counter etc.) upon which closeable container 1 is resting in FIG. 1) of the tub 2. In some implementations, only a portion of the edges are vertical relative to the surface 35.

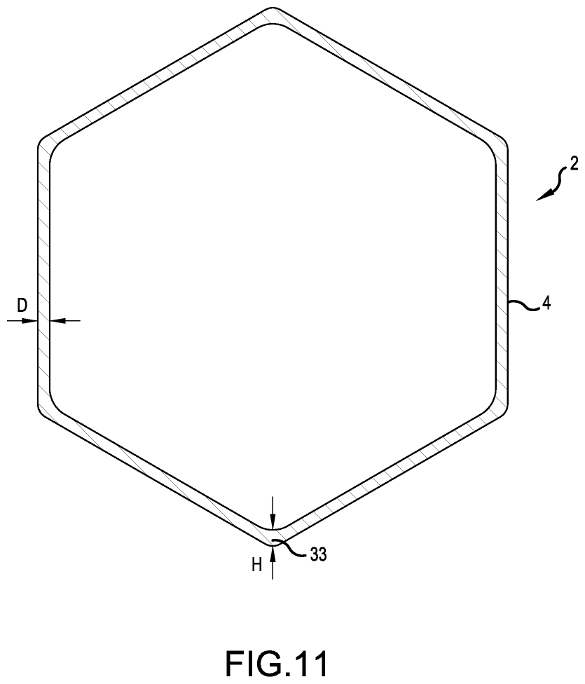

For example, a given rigid edge of the rigid edges 33 may be defined at an intersection of two of the of the one or more sidewalls 4. The edges may be reinforced and thus rigid by having a thickness (e.g. thickness H of FIG. 11) that is greater than a thickness (e.g. thickness D of FIGS. 7, 11) of one or more portions of the one or more sidewalls 4 that are not associated with the rigid edges 33.

One or more corners 20 that are configured to function as one or more pour spouts are now described with reference to FIGS. 5, 11, and 13. In some implementations, the one or more rigid edges 33 and the rim 19 of the one or more side-walls 4 define one or more corners 20 that are configured to function as one or more pour spouts. For example, the one or more sidewalls 4 may be configured to be squeezable and deformable by a user to facilitate use of the one or more corners 20 as one or more pour spouts for pouring a liquid from an interior chamber 15 of the tub 2 via the one or more pour spouts. These one or more pour spouts assist with preparation of product when the preparation of product includes at least introduction of liquid into and emptying of liquid from the interior chamber 15 of the tub 2.

A lid and a channel closure system are now discussed with reference to FIGS. 4, 6, 7, 10, and 12. Some implementations provide a closeable container 1 with a lid 3 that firmly attaches to one or more side walls 4 of a tub 2 to seal an interior chamber 15 defined by the tub 2. The lid 3 and tub 2 include a channel closure system 16 that creates contact friction between the lid 3 and both one or more upper interior surfaces 29 and one or more upper outer surfaces 32 of the one or more side walls 4. The channel closure system 16 includes at least a channel 17 defined by the lid 3 that contacts the one or more upper interior surfaces 29 and the one or more upper outer surfaces 32 of the one or more side walls 4 when a rim 19 defined by the one or more side walls 4 is inserted into the channel 17. In some implementations the one or more upper interior surfaces 29 and the one or more upper outer surfaces 32 may be defined as the portions of the one or more outer surfaces 6 and one or more interior surfaces 5 of the one or more side walls 4 that fit within channel 17 when the rim 19 is inserted into the channel 17. In some implementations the one or more upper interior surfaces 29 and the one or more upper outer surfaces 32 of the one or more side walls 4 have a length I as indicated of FIG. 7. In some implementations length I is ½ inch. In some other implementations, length I is ¾ of an inch. Thus in some implementations, the lid (e.g. lid 3) and the one or more side walls (e.g. side walls 4) are configured with a channel closure system (e.g. channel closure system 16), the channel closure system (e.g. channel closure system 16) including a channel (e.g. channel 17) defined by the lid (e.g. lid 3) that is configured to contact one or more upper interior surfaces (e.g. upper interior surfaces 29) and the one or more upper outer surfaces (e.g. upper outer surfaces 32) of the one or more side walls (e.g. side walls 4) when the rim (e.g. rim 19) is inserted into the channel (e.g. channel 17).

In some implementations, the channel closure system 16 further includes at least a gripping feature 18 for added friction contact when the rim 19 is inserted into the channel 17. The gripping feature 18 may include one or more first ridges 31 defined on at least one of the one or more upper interior surfaces 29 or the one or more upper outer surfaces 32 of the one or more side walls 4 and one or more second ridges 28 defined in the channel 17. The one or more first ridges 31 being configured to mate with the one or more second ridges 28 to provide additional friction contact between the lid 3 and the tub 2. Other forms of gripping features are possible, including having one or more protrusions (not shown) extending from one or more surfaces of the channel 17 to protrude against and to make friction contact with the one or more side walls 4. Thus in some implementations, the channel (e.g. channel 17) of the channel closure system (e.g. channel closure system 16) includes at least a gripping feature (e.g. gripping feature 18) that is configured to provide contact friction between the channel (e.g. channel 17) and at least one of the one or more upper interior surfaces (e.g. upper interior surfaces 29) or the one or more upper outer surfaces (e.g. upper outer surfaces 32) of the one or more side walls (e.g. side walls 4) when the rim (e.g. rim 19) is inserted in the channel (e.g. channel 17). And in some further implementations, the gripping feature (e.g. gripping feature 18) includes at least one or more ridges (e.g. the one or more second ridges 28) in the channel (e.g. channel 17).

A lid deboss and a base wall useful for stacking closeable containers are now described with reference to FIGS. 1, 2, 3, 4, 6, 7, 8, 10, and 12. In some implementations closeable container 1 includes at least a lid 3 with a lid deboss 11 (e.g. an indentation, a depression, a recess, etc.) and a tub 2 with a base step 10 (e.g. a notch, a recess, and indentation) around a perimeter (e.g. a perimeter parallel to base wall 9) of tub 2 that narrows at least the base wall 9 to fit within and dock with a lid deboss 11 of another closeable container 1. In some implementations, the lid deboss 11 faces upward—e.g. opposite the base wall 9 when the lid is attached to the tub 2. In some implementations the base step 10 is defined in at least one of the one or more side walls 4 or the base wall 9.

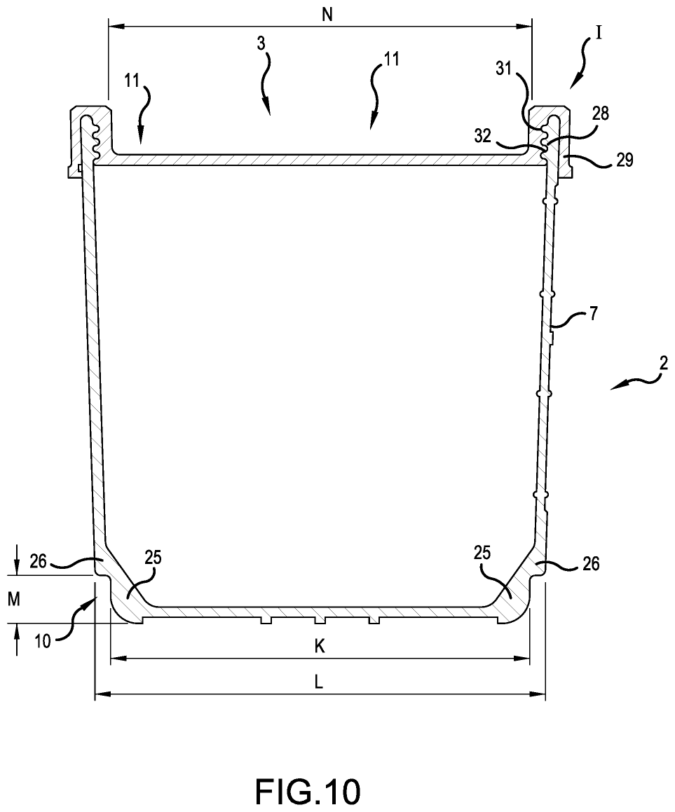

For example, a base step may be defined in at least one of the one or sidewalls 4 or the base wall 9. The base step 10 may encircle the tub 2 parallel to the base wall 9. In some implementations the base step begins with the second band 26 discussed above and descends (relative to base wall 9) until ending with the first band 25 discussed above. In some implementations, base step 10 may at the first band 25 define a first diameter (e.g. diameter K, FIG. 10) and may at the second band 26 define a second diameter (e.g. diameter L, FIG. 10), the first diameter being smaller than the second. The base wall 9 with the first diameter is sized to insert in (e.g. fit in, dock with, mate with etc.) the lid deboss 11 with diameter N of FIG. 10. Base step 10 has a height M (e.g. relative to base wall 9) that may be a distance between the first band 25 and the second band 26.

Thus, in some implementations, a closable container (e.g. closeable container 1) includes at least a lid deboss (e.g. lid deboss 11) as part of the lid (e.g. lid 3) and wherein the base wall (e.g. base wall 9) is configured for insertion (e.g. by shape, dimensions, etc.) into the lid deboss (e.g. lid deboss 11). In some further implementations, a closable container (e.g. closeable container 1) includes at least a lid deboss (e.g. lid deboss 11) as part of the lid (e.g. lid 3) and a base step (e.g. base step 10) defined in at least one of the one or more side walls (e.g. side walls 4) or the base wall (e.g. base wall 9), the base step (e.g. base step 10) causing a narrowing of the tub (e.g. tub 2) at the base wall (e.g. base wall 9) that configures the base wall (e.g. base wall 9) with at least a size (e.g. Dimension K of FIG. 10) for insertion of the base wall (e.g. base wall 9) into the lid deboss (e.g. lid deboss 11 with Dimension N of FIG. 10).

The lid deboss 11 and base wall 9 (e.g. narrowed by a base step 10 relative to a diameter of at least a portion of the one or more side walls 4) allow one closeable container 1 to sit directly atop another, giving the containers better stacking ability that is useful for storage and transportation of the closeable container 1.

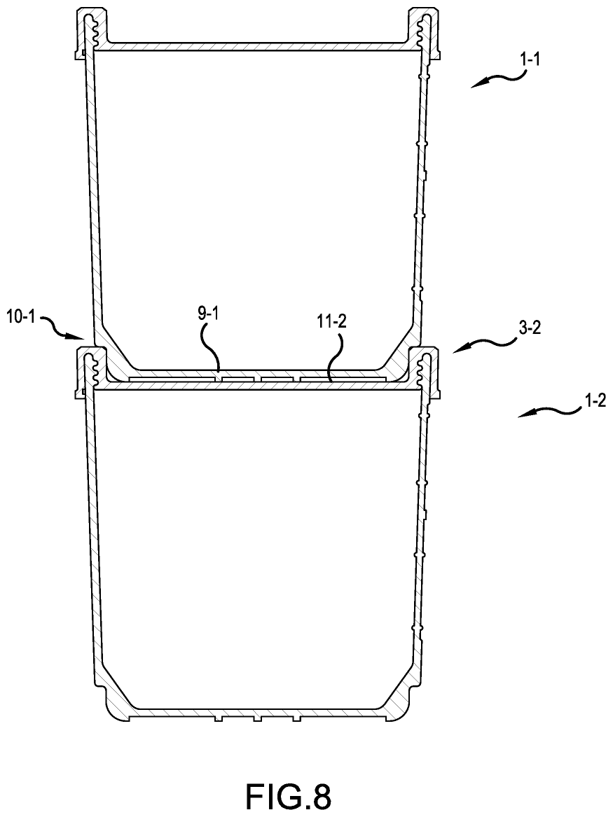

Thus, referencing FIG. 8, a base step 10-1 in the bottom of a first closeable container 1-1 results in a narrowed base wall 9-1 of first closeable container 1-1. The narrowed base wall 9-1 being insertable into the lid deboss 11-2 of a lid 3-2 of a second closable container 1-2 for purposes of stacking the first closable container 1-1 on top of the second closable container 1-2.

As discussed above, in some implementations an closable container may include the one or more of the at least one window 7, the one or more measurement lines 8, two or more thick lateral reinforcing bands 25, 26, the one or more inclined interior bottom surfaces 12, the one or more corners 20 that are configured to function as one or more pour spouts, the channel closure system 16, the one or more rigid edges 13, or a narrowed base wall 9 for insertion into (e.g. fit into, dock with, mate with, etc.) a lid deboss 11 to facilitate stacking. Some implementations may include some of the above features, but not others. For example, an implementation may include a window 7 without measurement lines 8. Another implementation may lack rigid edges. In various implementations any combination of the above is possible.

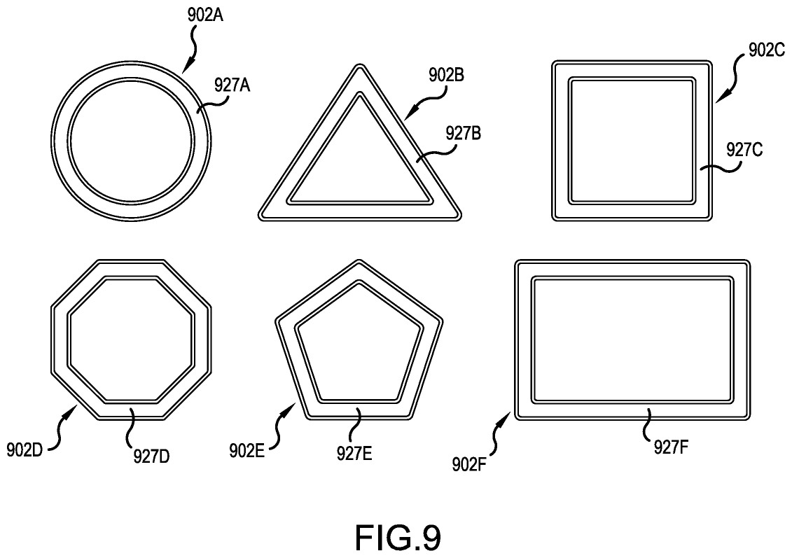

Various shapes for a closable container 1 are now discussed relative to FIG. 9. The tub 2 of the closable container 1 shown in FIGS. 1-8 and 10-13 is hexagonally shaped in a top view. Lid 3 is also hexagonally shaped. However, other shapes are possible. For example, FIG. 9 illustrates, in a top view (e.g. relative to base wall 9), tub 902A with a circular shape 927A, tub 902B with a triangular shape 927B, tub 902C with a square shape 927C, tub 902D with an octagonal shape 927D, tub 902E with a pentagonal shape 927E, and tub 902F with a rectangular shape 927F. The various shaped implementations may also include one or more of the one or more of the at least one window 7, the one or more measurement lines 8, two or more thick lateral reinforcing bands 25, 26, the one or more inclined interior bottom surfaces 12, the one or more corners 20 that are configured to function as one or more pour spouts, the channel closure system 16, the one or more rigid edges 13, or a narrowed base wall 9 for insertion into (e.g. fit into, dock with, mate with) a lid deboss 11 to facilitate stacking.

### Description of Exemplary Process:

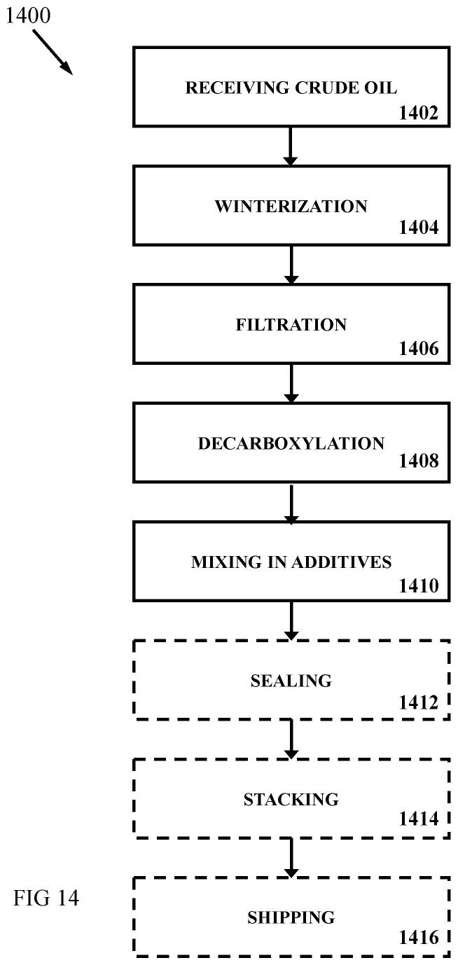

An exemplary method 1400 of using a closable container is now discussed with reference to FIG. 14. In discussing method 1400, reference is also made to various items from FIGS. 1-13, as examples of structures that could be used to implement exemplary method 1400.

While process blocks 1402-1416 are discussed, it is noted that process blocks which are bordered in broken line and are optional. In addition, the ordering of the process blocks does not imply that the actions described in the process blocks must be performed in the order described below. Although crude oil is discussed at a raw material being processed, this is not intended to be limiting. In some implementations, non-oil substances may be processed in a similar manner. In some implementations, the crude oil may be a cannabinoid. In some implementations, the cannabinoid may be CBD oil.

Referencing process block 1402 regarding receiving crude oil, in some implementations, crude oil is received through an opening (e.g. opening 21) in interior chamber (e.g. interior chamber 15) of a tub (e.g. tub 2) of an closable container (e.g. closable container 1) for processing consistent with various implementations, the closable container being at least partially made of silicon. In some implementations, the crude oil is CBD oil. In some implementations, a non-oil product may be received in the interior chamber for processing.

Referencing process block 1404 regarding winterization, including mixing and chilling, in some implementations winterization is performed on the crude oil. In some implementations winterization includes at least mixing the crude oil while it is in the interior chamber with ethanol and chilling the mixture by placing the mixture in the closable container in a cold environment of between minus 15 degrees and minus 25 degrees Celsius for a period of time that is between 24 and 48 hours, the winterization causing substances in the crude oil to at least one of coagulate or solidify. In some implementations the mixing of the crude oil with ethanol is facilitated by two or more thick lateral reinforcing bands (e.g. first band 25 and second band 26 that stabilize tub 2). In some implementations the mixing of the crude oil with ethanol is facilitated by one or more rigid edges (e.g. rigid edges 13). In some implementations the chilling of the mixture may include sealing the tub with a lid (e.g. lid 3) to form an air-tight seal while it is being chilled. In some implementations the air-tight seal is facilitated by a channel closure system (e.g. channel closure system 16).

Referencing process block 1406 regarding filtration, in some implementations filtration is performed on the winterized oil. In some implementations, filtration includes at least filtering out at least one of a coagulated substance or a solidified substance (e.g. impurities coagulated and/or solidified by winterization) from the winterized oil. In some further implementations filtration includes at least pouring the winterized oil out of the interior chamber of the tub 2 via the pour spouts (e.g. pour spouts). In some implementations filtration further includes at least pouring back into interior chamber 15 using a funnel (not shown) with a perforated disc (not shown) to filter out one or more of fats, waxes, flavonoids, or other undesirable compounds that were at least one of solidified and coagulated during winterization. For different types of impurities there is utilization of different sized particulate filters (screen filtration).

Referencing process block 1408 regarding decarboxylation, in some implementations decarboxylation is performed on the filtered oil. In some implementations decarboxylation includes at least heating the winterized and filtered oil to a temperature and for a duration sufficient to remove 99% of the ethanol from the oil. In some implementations decarboxylation includes at least purifying the filtered oil by “burning off” (e.g. evaporating out of solution) the remaining ethanol and activating the oil (e.g. CBD). This may be performed by exposing the oil and tub to heat, such as with at least one of a stove top or an oven, at temperatures ranging from 100−160° C. for extended periods of time in a container. In some implementations this extended period of time ranges from 30 minutes to twelve hours. In some implementations, this decarboxylation may be facilitated by the silicone content of tub which tolerates the temperatures used.

Referencing process block 1410 regarding mixing in additives, in some implementations additives are added to the decarboxylated oil. This may include mixing one or more additives to the oil to achieve a finished product suitable for shipping in the closeable container. In some implementations, dependent upon a desired finished product, the additives may include one or more of essentials oils, coconut oil, arnica, beeswax, shea butter, olive oil, terpenes, preservatives, honey, grape seed oil, almond oil, or other additive. In some implementations the mixture additives are added by via an overhead industrial mixer, which is aided by the one or more inclined interior bottom surfaces 12. In some implementations the mixing in additives may result in a finished product. In some implementations this finished product may include at least one of a muscles salve, a CBD tincture, a lotion, a topical spray, an oil, a food product, or other product.

Referencing process block 1412 regarding an optional sealing operation, in some implementations method 1600 optionally includes at least placing a lid (e.g. lid 3) over an upper rim (e.g. rim 19) of the closeable container (e.g. closable container 1) to sealing engage with the rim via a channel closure system (e.g. channel closure system 16).

Referencing process block 1414 regarding an optional stacking operation, in some embodiments, after the sealing of process block 1412, a sealed closeable container is stacked on top of another closeable container. In some implementations, for example as illustrated in FIG. 8, this includes at least stacking the closeable container (e.g. closable container 1-1) on top of the other closeable container (e.g. closable container 1-2), including at least mating a base wall (e.g. base wall 9-1) of the closable container (e.g. closable container 1-1) with a lid deboss (e.g. lid deboss 11-2) of the other closable container (e.g. closable container 1-2). This operation may be followed by shipment or storage.

Referencing process block 1416, in some implementations, after the sealing of process block 1412, exemplary method 1400 optionally includes at least shipping the oil in the sealed closable container.

Some embodiments are now discussed.

Embodiment 1. An closable container comprising:
(a) a semi-rigid tub that is composed at least partly of silicone and that includes at least:
   (1) a base wall, including a floor of the tub;
   (2) one or more side walls defining a junction with the base wall and extending from the junction to a rim, the one or more side walls including one or more interior surfaces that together with the floor define an interior chamber of the tub; and
   (3) at least one window formed in at least one side wall of the one or more side walls that is at least one of at least partially transparent or translucent; and
(b) a semi-rigid lid composed at least partially of silicone and configured to sealingly mate with the one or more side walls via the rim.

Embodiment 2. The closable container of embodiment 1, wherein the at least one window includes at least one measurement line at least one of embossed or formed in material of the at least one window.

Embodiment 3. The closable container of embodiment 2, wherein the at least one window includes at least one measurement line that is at least one or embossed or formed on an interior side, facing the interior chamber, of the at least one window and at least one measurement line that is at least one or embossed or formed on an exterior side of the at least one window.

Embodiment 4. The closable container of any of embodiments 1-3, wherein the junction defines a first band circumscribing the tub that has a thickness that is at least twice as great as a thickness of at least a portion of the one or more side walls that is not associated with a band.

Embodiment 5. The closable container of embodiment 4, wherein the one or more side walls define a second band spaced from first band, the second band having a thickness that is at least twice as great as the thickness of the at least a portion of the one or more side walls that is not associated with a band.

Embodiment 6. The closable container of any of embodiments 1-5, wherein the interior chamber includes at least one or more inclined interior bottom surfaces that extend from the junction, the one or more inclined interior bottom surfaces defining at least a first diameter at the junction and further defining t least a second diameter at an end of the one or more inclined interior bottom surfaces, the second diameter being greater than the first diameter.

Embodiment 7. The closable container of any of embodiments 1-6, wherein the one or more sidewalls define one or more rigid edges.

Embodiment 8. The closable container of embodiment 7, wherein the one or more rigid edges define a thickness that is greater than a thickness of one or more portions of the one or more side walls that are not associated with the one or more rigid edges.

Embodiment 9. The closable container of any of embodiments 7-8, wherein the one or more rigid edges and the rim of the one or more side walls define one or more corners and wherein the one or more corners are configured to function as one or more pour spouts, one or more portions of the one or more side walls being at least one of squeezable or deformable to facilitate use of the one or more corners as one or more pour spouts, the one or more pour spouts being suitable for pouring liquid from the interior chamber via the one or more pour spouts.

Embodiment 10. The closable container of any of embodiments 1-9 wherein the lid and the one or more side walls are configured with a channel closure system, the channel closure system including a channel defined by the lid that is configured to contact one or more upper interior surfaces and one or more upper outer surfaces of the one or more side walls when the rim is inserted into the channel.

Embodiment 11. The closable container of embodiment 10, wherein the channel of the channel closure system includes a gripping feature that is configured to provide contact friction between the channel and at least one of the one or more upper interior surfaces or the one or more upper outer surfaces of the one or more side walls when the rim is inserted in the channel.

Embodiment 12. The closable container of embodiment 11, wherein the gripping feature includes at least one or more ridges in the channel.

Embodiment 13. The closable container of any of embodiments 1-12, further comprising:
a lid deboss as part of the lid; and
wherein the base wall is configured for insertion into the lid deboss.

Embodiment 14. The closable container of any of embodiments 1-13, wherein each of the tub and the lid are composed at of at least 90 percent food-grade silicone.

Embodiment 15. The closable container of any of embodiments 1-14, wherein the one or more side walls define at least one of a hexagon, a circle, an octagon, a triangle, or a rectangle in a top view.

Embodiment 16. A method of using an closable container, the method comprising:
(a) receiving a crude oil through an opening in an interior chamber of a tube of the closable container, the closable container being at least partially composed of silicone;
(b) performing winterization of the crude oil, the winterization including at least:
   (1) mixing the crude oil while it is in the interior chamber with ethanol; and
   (2) placing the closable container in a cold environment of between minus 15 degrees and minus 25 degrees Celsius for a period of time that is between 24 and 48 hours, the winterization causing substances in the crude oil to at least one of coagulate or solidify;
(c) filtering out at least one of a coagulated substance or a solidified substance from the winterized oil;
(d) performing decarboxylation by heating the filtered and winterized oil to a temperature and for a duration sufficient to remove 99% of the ethanol from the oil; and
(e) mixing one or more additives to the oil to achieve a finished product suitable for shipping in the closable container.

Embodiment 17. The method of embodiment 16, wherein the method further comprises: placing a lid over an upper rim of the closable container to sealing engage with the rim via a channel closure system.

Embodiment 18. The method of embodiment 17, wherein the method further comprises:

stacking the closable container on top of another closable container, including at least mating a base step of the closable container with a lid deboss of the other closable container.

Embodiment 19. The method of any of embodiments 17-18, wherein the method further includes shipping the oil in the sealed closable container.

I will be understood by those skilled in the art that the terminology used in this specification and in the claims is “open” in the sense that the terminology is open to additional elements not enumerated. For example, the words “includes” should be interpreted to mean “including at least” and so on. In addition, articles such as “a” or “the” should be interpreted as not referring to a specific number, such as one, unless explicitly indicated. At times a convention of “at least one of A, B, or C” is used, the intent is that this language includes any of A alone, B alone, C alone, A and B, B and C, A and C, or all of A, B, and C. The same is indicated by the conventions “one of more of A, B, or C.” Similarly, the phrase “A, B, and/or C” is intended to include any of A alone, B alone, C alone, A and B, B and C, A and C, or all of A, B, and C. With parentheticals such as (e.g. A, B, C). It is intended that this refer to any or all of A alone, B alone, or C alone and to any combination thereof that is applicable in the particular context.

And as previously indicated elements, components, or operations should not be regarded as essential unless they are so explicitly described. The teaches contained herein may be adapted to a variety of implementations arranged and composed in a wide variety of ways.

The above description of various implementations is intended to be illustrative not exhaustive and is not intended to limit this disclosure, its application, or uses. Those skilled in the art will be able to imagine implementations not described but that are consistent with the principles and teachings described herein. Therefore, the above description of exemplary implementations is not intended to limit the scope of this disclosure, which should be defined only in accordance with the following claims and equivalents thereof.

We claim:

1. An closable container comprising:
(a) a semi-rigid tub that is composed at least partly of silicone and that includes at least:
(1) a base wall, including a floor of the tub;
(2) one or more side walls defining a junction with the base wall and extending from the junction to a rim, the one or more side walls including one or more interior surfaces that together with the floor define an interior chamber of the tub; and
(3) at least one window formed in at least one side wall of the one or more side walls that is at least one of at least partially transparent or translucent; and
(b) a semi-rigid lid composed at least partially of silicone and configured to sealingly mate with the one or more side walls via the rim.

2. The closable container of claim 1, wherein the at least one window includes at least one measurement line at least one of embossed or formed in material of the at least one window.

3. The closable container of claim 2, wherein the at least one window includes at least one measurement line that is at least one or embossed or formed on an interior side, facing the interior chamber, of the at least one window and at least one measurement line that is at least one or embossed or formed on an exterior side of the at least one window.

4. The closable container of claim 1, wherein the junction defines a first band circumscribing the tub that has a thickness that is at least twice as great as a thickness of at least a portion of the one or more side walls that is not associated with a band.

5. The closable container of claim 4, wherein the one or more side walls define a second band spaced from first band, the second band having a thickness that is at least twice as great as the thickness of the at least a portion of the one or more side walls that is not associated with a band.

6. The closable container of claim 1, wherein the interior chamber includes at least one or more inclined interior bottom surfaces that extend from the junction, the one or more inclined interior bottom surfaces defining at least a first diameter at the junction and further defining t least a second diameter at an end of the one or more inclined interior bottom surfaces, the second diameter being greater than the first diameter.

7. The closable container of claim 1, wherein the one or more sidewalls define one or more rigid edges.

8. The closable container of claim 7, wherein the one or more rigid edges define a thickness that is greater than a thickness of one or more portions of the one or more side walls that are not associated with the one or more rigid edges.

9. The closable container of claim 7, wherein the one or more rigid edges and the rim of the one or more side walls define one or more corners and wherein the one or more corners are configured to function as one or more pour spouts, one or more portions of the one or more side walls being at least one of squeezable or deformable to facilitate use of the one or more corners as one or more pour spouts, the one or more pour spouts being suitable for pouring liquid from the interior chamber via the one or more pour spouts.

10. The closable container of claim 1, wherein the lid and the one or more side walls are configured with a channel closure system, the channel closure system including a channel defined by the lid that is configured to contact one or more upper interior surfaces and one or more upper outer surfaces of the one or more side walls when the rim is inserted into the channel.

11. The closable container of claim 10, wherein the channel of the channel closure system includes a gripping feature that is configured to provide contact friction between the channel and at least one of the one or more upper interior surfaces or the one or more upper outer surfaces of the one or more side walls when the rim is inserted in the channel.

12. The closable container of claim 11, wherein the gripping feature includes at least one or more ridges in the channel.

13. The closable container of claim 1, further comprising:
a lid deboss as part of the lid; and
wherein the base wall is configured for insertion into the lid deboss.

14. The closable container of claim 1, wherein each of the tub and the lid are composed at of at least 90 percent food-grade silicone.

15. The closable container of claim 1, wherein the one or more side walls define at least one of a hexagon, a circle, an octagon, a triangle, or a rectangle in a top view.

16. A method of using an closable container, the method comprising:
(a) receiving a crude oil through an opening in an interior chamber of a tube of the closable container, the closable container being at least partially composed of silicone;
(b) performing winterization of the crude oil, the winterization including at least:
(1) mixing the crude oil while it is in the interior chamber with ethanol; and
(2) placing the closable container in a cold environment of between minus 15 degrees and minus 25 degrees Celsius for a period of time that is between 24 and 48 hours, the winterization causing substances in the crude oil to at least one of coagulate or solidify;
(c) filtering out at least one of a coagulated substance or a solidified substance from the winterized oil;
(d) performing decarboxylation by heating the filtered and winterized oil to a temperature and for a duration sufficient to remove 99% of the ethanol from the oil; and
(e) mixing one or more additives to the oil to achieve a finished product suitable for shipping in the closable container.

17. The method of claim 16, wherein the method further comprises:
placing a lid over an upper rim of the closable container to sealing engage with the rim via a channel closure system.

18. The method of claim 17, wherein the method further comprises:
stacking the closable container on top of another closable container, including at least mating a base step of the closable container with a lid deboss of the other closable container.

19. The method of claim 17, wherein the method further includes shipping the oil in the sealed closable container.

20. An closable container comprising:
(a) a semi-rigid tub that is composed of at least 90 percent silicone and that includes at least:
(1) a base wall, including a floor of the tub;
(2) one or more side walls defining a junction with the base wall and extending from the junction to a rim, the one or more side walls including one or more interior surfaces that together with the floor define an interior chamber of the tub, the junction defines a band circumscribing the tub that has a thickness that is at least twice as great as a thickness of at least a portion of the one or more side walls; and
(3) at least one window formed in at least one side wall of the one or more side walls that is at least one of at least partially transparent or translucent; and
(b) a semi-rigid lid composed at least partially of silicone and configured to sealingly mate with the one or more side walls via the rim, the lid configured with a channel for insertion of the rim in the channel.
